(19) United States
(12) Patent Application Publication
(10) Pub. No.: US 2024/0106579 A1
(43) Pub. Date: Mar. 28, 2024

(54) Soft HARQ Feedback Reporting Density, Enabling Mechanism, Processing Timeline And Codebook Construction In Mobile Communications

(71) Applicant: MediaTek Singapore Pte. Ltd., Singapore (SG)

(72) Inventors: Jozsef Gabor Nemeth, Cambridge (GB); Waseem Hazim Ozan Ozan, Cambridge (GB); Mohammed S Aleabe Al-Imari, Cambridge (GB)

(21) Appl. No.: 18/273,113

(22) PCT Filed: Jan. 19, 2022
(86) PCT No.: PCT/CN2022/072709

§ 371 Date: Jul. 19, 2023

Related U.S. Application Data
(60) Provisional application No. 63/139,466, filed on Jan. 20, 2021.

(51) Int. Cl. H04L 1/1829; H04L 1/1825

(52) U.S. Cl. CPC H04L 1/1864; H04L 1/1825; H04L 1/1854

(57) ABSTRACT

Various examples pertaining to soft hybrid automatic repeat request (HARQ) feedback reporting density, enabling mechanism, processing timeline and codebook construction in mobile communications are described. An apparatus, implementable in a user equipment (UE), receives one or more transmissions from a network node. The apparatus generates one or more soft HARQ feedbacks corresponding to the one or more transmissions and then transmits the one or more soft HARQ feedbacks to the network node.

### CROSS REFERENCE TO RELATED PATENT APPLICATION(S)

The present disclosure is part of U.S. National Stage filing of International Patent Application No. PCT/CN2022/072709, filed 19 Jan. 2022, which is part of a non-provisional application claiming the priority benefit of U.S. Patent Application No. 63/139,466, filed on 20 Jan. 2021, the content of which being incorporated by reference in its entirety.

### TECHNICAL FIELD

The present disclosure is generally related to mobile communications and, more particularly, to soft hybrid automatic repeat request (HARQ) feedback reporting density, enabling mechanism, processing timeline and code construction in mobile communications.

### BACKGROUND

Unless otherwise indicated herein, approaches described in this section are not prior art to the claims listed below and are not admitted as prior art by inclusion in this section.

In wireless communications, such as mobile communications under the 3rd Generation Partnership Project (3GPP) specification(s) for 5th Generation (5G) New Radio (NR), downlink (DL) HARQ typically refers to the transfer of DL data on a physical downlink shared channel (PDSCH) with HARQ acknowledgements returned on either a physical uplink control channel (PUCCH) or a physical uplink shared channel (PUSCH). A user equipment (UE) reports an acknowledgement (ACK) to a base station (e.g., gNB) upon successful PDSCH decoding or the UE reports a negative acknowledgement (NACK) otherwise.

An outer loop link adaptation (OLLA) may be implemented at the gNB to maintain a desired block error ratio (BLER). A typical operation by a gNB is to increase a signal-to-noise ratio (SNR)-margin with a certain value upon NACK reception. This yields a reduced effective signal-to-interference-and-noise ratio (SINR) that is used for modulation coding scheme (MCS) selection, thus resulting in a lower MCS selection. The gNB may operate similarly to decrease the SNR-margin upon ACK reception. Depending on the desired BLER, the ratios of ACK and NACK adjustments can be varied. The OLLA may work well for initial transmission with an error rate target of about 10% with a target BLER equal to 0.1 (e.g., for enhanced mobile broadband (eMBB)). However, in ultra-reliable low-latency communication (URLLC) with a low target BLER, there may not be enough NACK events for the outer loop of OLLA to converge. One way to utilize OLLA is to make the outer loop act on events before those events lead to a block error. This may be achieved by sending soft HARQ. With respect to OLLA and the number of HARQ feedbacks, in eMBB the OLLA performance is acceptable as the number of received NACKs is sufficient; however, in URLLC this is not the case as the number of NACKs tends to be very low. With respect to processing timeline, N1 is defined as the time needed for PDSCH decoding and HARQ feedback preparation. However, the preparation for soft HARQ may require a different processing timeline. Therefore, there is a need for a solution of soft HARQ feedback reporting density, enabling mechanism, processing timeline and code construction in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving soft HARQ feedback reporting density, enabling mechanism, processing timeline and code construction in mobile communications. For instance, as OLLA performance is acceptable in eMBB, a reduced density for soft HARQ reports may be implemented, such as one soft HARQ report per M (>1) existing HARQ reports.

In one aspect, a method may involve receiving one or more transmissions from a network node. The method may also involve generating one or more soft HARQ feedbacks corresponding to the one or more transmissions. The method may further involve transmitting the one or more soft HARQ feedbacks to the network node.

In another aspect, an apparatus may include a transceiver and a processor coupled to the transceiver. The transceiver may be configured to communicate wirelessly. The processor may be configured to receive, via the transceiver, one or more transmissions from a network node, generate one or more soft HARQ feedbacks corresponding to the one or more transmissions, and transmit, via the transceiver, the one or more soft HARQ feedbacks to the network node.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a proposed scheme in accordance with the present disclosure.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to soft HARQ feedback reporting density, enabling mechanism, processing timeline and code construction in mobile communications. According to the present disclosure, a number of possible solutions may be implemented separately or jointly. That is, although these possible solutions may be described below separately, two or more of these possible solutions may be implemented in one combination or another.

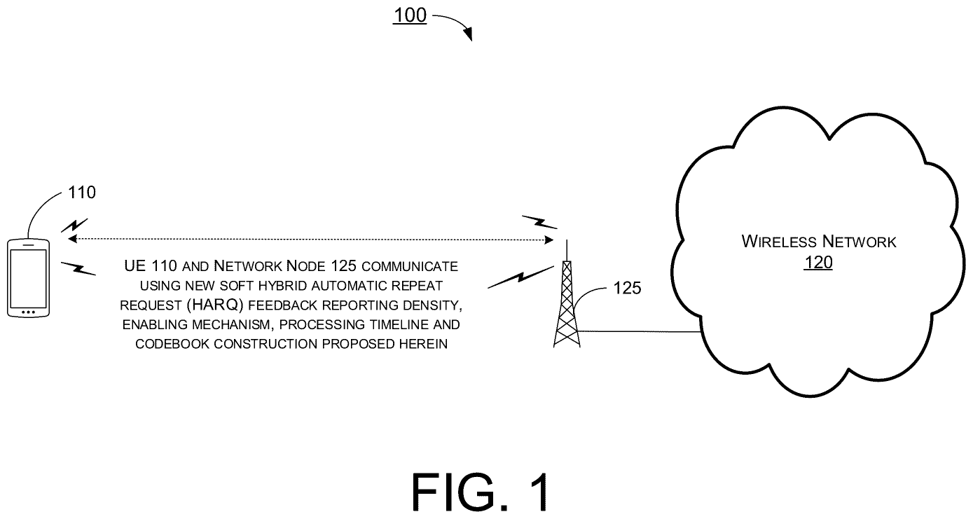

FIG. 1 illustrates an example network environment 100 in which various solutions and schemes in accordance with the present disclosure may be implemented. Referring to FIG. 1, network environment 100 may involve a UE 110 in wireless communication with a wireless network 120 (e.g., a 5G NR mobile network or another type of network such as an NTN). UE 110 may be in wireless communication with wireless network 120 via a base station or network node 125 (e.g., an eNB, gNB or transmit-receive point (TRP)). In network environment 100, UE 110 and wireless network 120 (via network node 125) may implement various schemes pertaining to soft HARQ feedback reporting density, enabling mechanism, processing timeline and code construction in mobile communications, as described below.

Under a first proposed scheme in accordance with the present disclosure, UE 110 may report to network node 125 a percentage of soft information measured at UE 110. In the present disclosure, the term “soft information” refers to information that is not a binary value but value or information representative of the binary value, thereby achieving finer resolution. For instance, a raw bit error rate (BER) before recording may be represented by soft information in a soft HARQ feedback. Thus, UE 110 may report the measured or estimated soft information in the form of percentage value for soft HARQ feedback. Under the proposed scheme, UE 110 may convert the exact soft information values to percentage soft information values, with the latter being obtained by dividing the measured/estimated soft information values to a maximum value of that soft information. Afterwards, either UE 110 may report the exact percentage or quantized percentage of the soft information or UE 110 may map the percentage information into a soft ACK and/or soft NACK. For example, considering the soft information being the low-density parity-check (LDPC) decoding iterations obtained at UE 110 and being equal to 9 iterations, and the maximum number of the LDPC decoding iterations for UE 110 being 12 iterations, UE 110 may determine or otherwise calculate the percentage as:

$$\begin{matrix}Percentage soft information = \frac{Measured ( or estimated ) soft information}{Max value of that soft information} \\ = \frac{9}{12} = 75 \%\end{matrix}$$

Then, UE 110 may report the exact (or quantized) percentage information values. Alternatively, or additionally, UE 110 may map the percentage into a soft ACK/soft NACK.

Under this proposed scheme, different options of sources of information may be defined and utilized. For instance, the sources of information may include, for example and without limitation, the number of LDPC decoding iterations, the time needed to complete the PDSCH decoding process, the log-likelihood ratio (LLR) values (or magnitudes only) and/or variance, the flipped bits, and the raw bit error rate (BER).

Under a second proposed scheme in accordance with the present disclosure, UE 110 may reduce the soft HARQ based on time. That is, the number of soft HARQ feedback reported by UE 110 to network node 125 may be lower than the number of the existing HARQ feedbacks. The reduction in the soft HARQ feedback reports may be based on reducing the number of soft HARQ feedbacks in a given period of specific N time units (with N≥1). For instance, the granularity of the N time units may be in sub-slots, slots or radio frames. Moreover, the N value may be set, applied or otherwise configured by different options. In a first option (option 1), the value of N may be configured/applied/set by higher-layer parameters (e.g., radio resource control (RRC) parameters). In a second option (option 2), the value of N may be pre-configured for each downlink control information (DCI) format separately, and the DCI selecting the PUCCH resource for the PUCCH transmission carrying HARQ may also select the value of N. In a third option (option 3), the value of N may be pre-configured for each HARQ format separate (e.g., type-1, type-2, type-3), and UE 110 may select the value of N previously configured with each HARQ format through RRC. In a fourth option (option 4), the value of N may be configured or applied according to the BLER target. In a fifth option (option 5), the value of N may be configured or applied per configured bandwidth part (BWP) and/or the configured numerology (e.g., bandwidth subcarrier spacing). In a sixth option (option 6), the value of N may be configured or applied according to the UE (e.g., with the UE itself calculating the N value). In a seventh option (option 7), the value of N may be configured or applied according to the codebook priority. In an eight option (option 8), different combinations of two or more of the aforementioned options may be used, applied or otherwise configured.

Under this proposed scheme, the measurements of a soft HARQ feedback report per N time unit may be based on factors of different options. In a first option (option 1), the measurements of a soft HARQ feedback report may be based on N PDSCHs from N sub-slots, N slots or N radio frames. In a second option (option 2), the measurements of a soft HARQ feedback report may be based on a single PDSCH per N time units, where the PDSCH may be selected as the PDSCH with the worst decoding performance or the best decoding performance. In a third option (option 3), the measurements of a soft HARQ feedback report may be based on multiple PDSCHs from the N time units, where the multiple PDSCHs may be selected as the PDSCHs with the worst decoding performance or the best decoding performance. In a fourth option (option 4), the measurements of a soft HARQ feedback report may be based on the PDSCH(s) that is/are successfully decoded (e.g., that passed cyclic redundancy check (CRC)). In a fifth option (option 5), the measurements of a soft HARQ feedback report may be based on the PDSCH(s) that is/are unsuccessfully decoded (e.g., that did not pass the CRC).

Under a third proposed scheme in accordance with the present disclosure, a new UE processing timeline for the preparation time needed for soft HARQ feedback may be introduced. That is, a new UE processing timeline may be defined to account for the soft HARQ preparation period. The new UE processing timeline may be defined to include the PDSCH decoding time as well as the soft HARQ feedback and the existing HARQ feedback preparation time. In some implementations, the new UE processing timeline may be based on the UE capabilities and/or the numerology. In some implementations, an existing UE processing timeline (e.g., N1) may be extended to accommodate the preparation time needed for soft HARQ feedback. For instance, the new US processing timeline may be expressed as N1+d, where d denotes the time period extension needed for soft HARQ preparation. In one approach, the processing timeline N1 may be extended without any condition. For example, a specific time period (such as one or two symbols) may be added to N1 to account for the latency required for soft HARQ preparation. In another approach, the N1 processing timeline may be extended with some conditions. For example, a conditional time variable may be added to the processing timeline N1 based on different conditions, such as the soft HARQ generation method, numerology, and the like.

In some implementations, the new UE processing timeline may be extended based on different UE capabilities. For example, two processing timeline capabilities may be defined for such purpose. In some implementations, the required processing time may be reported by UE 110 as a UE capability. For example, in an event that the new timeline is N1+d where d denotes the time period extension needed for soft HARQ preparation, the value of d may be reported to network node 125 as a UE capability. In some implementations, the new UE processing timeline may be extended based on the numerology (e.g., the subcarrier spacing). In some implementations, the new UE processing timeline may be applied, set or otherwise configured by higher-layer parameters (e.g., RRC parameters).

In some implementations, the new UE processing timeline may be applied or configured based on the configuration of demodulation reference signal (DMRS) position, which may be configured in DMRS-DownlinkConfig. In some implementations, the new UE processing timeline may be extended based on the PDSCH mapping type. For example, PDSCH mapping A and PDSCH mapping B may each have a different processing timeline period. In some implementations, the new UE processing timeline may be extended based on the type or method of generating the soft HARQ feedback. In some implementations, the new UE processing timeline may be extended based on the type or method of reporting or signaling the soft HARQ feedback. In some implementations, the new UE processing timeline may be extended based on the soft HARQ feedback reporting granularity. For example, the soft HARQ that is generated and reported per transport block (TB) may have a different processing timeline period than another soft HARQ generated and reported per codeblock group (CBG). In some implementations, the new UE processing timeline may be extended based on the soft HARQ feedback reporting density. For example, different options and embodiments of the first proposed scheme may have different processing timeline periods. In some implementations, the new UE processing timeline may change according to the number of symbols per PDSCH (e.g., the PDSCH size). In some implementations, the new UE processing timeline may be defined, applied or configured according to the configured BWP size. In some implementations, the new UE processing timeline may start from an end of the last symbol of the PDSCH carrying the TB or the CBG being acknowledged.

Under a fourth proposed scheme in accordance with the present disclosure, soft HARQ may be enabled and disabled based on the priority level. That is, soft HARQ may be enabled and disabled for high and low priorities separately. In some implementations, soft HARQ may be enabled/disabled based on the priority level of the HARQ-ACK feedback. In some implementations, the priority level may be what is indicated in DCI or configured in RRC. In some implementations, soft HARQ may be configured or enabled for the high priority. Alternatively, soft HARQ may be configured or enabled for the low priority. In some implementations, soft HARQ may be configured or enabled for both high and low priorities.

Under a fifth proposed scheme in accordance with the present disclosure, soft HARQ may be enabled and disabled based on the PDSCH scheduling mechanism. In some implementations, soft HARQ may be enabled and disabled for dynamic and semi-persistent PDSCH scheduling separately. For example, soft HARQ may be enabled only for HARQ-ACK feedback of dynamic PDSCH scheduling. Moreover, soft HARQ may be enabled only for semi-persistent scheduling (SPS) of the PDSCH. In some implementations, soft HARQ may be enabled and disabled based on the DCI format. In one option, soft HARQ may be enabled and disabled for a PDSCH scheduled by DCI 1_0. In another option, soft HARQ may be enabled and disabled for a PDSCH scheduled by DCI 1_1. In another option, soft HARQ may be enabled and disabled for a PDSCH scheduled by DCI 1_2. In another option, soft HARQ may be enabled and disabled for a PDSCH scheduled by either DCI 1_1 or DCI 1_2. In some implementations, soft HARQ may be enabled and disabled per SPS configuration.

With respect to codebook generation rules for reporting soft ACK/NACK instead of hard ACK/NACK, UE 110 may be configured by network node 125 to generate soft ACK/NACK bits instead of hard ACK/NACK bits for all the bits of selected codebooks or all codebooks. In the following proposed schemes, all codebook formats may be systematically extended from hard ACK/NACK bits to soft ACK/NACK bits.

Under a sixth proposed scheme in accordance with the present disclosure, soft ACK and soft NACK may be encoded using complementary sets of values based on the same number representation (e.g., bit width). A special value of soft NACK may be reserved to indicate unreported PDSCH (e.g., no scheduling has been detected, or ACK/NACK reporting is scheduled to a different uplink slot or sub-slot), or this information may be conveyed separately in the same codebook, or by other means after the HARQ codebook is sent. It is noteworthy that, as a UE (e.g., UE 110) may be configured by a network (e.g., network 120 via network node 125) to generate soft ACK/NACK bits instead of hard ACK/NACK bits for all the bits of selected or all codebooks. Accordingly, under the sixth proposed scheme, all codebook formats may systematically be extended from hard ACK/NACK bits to soft ACK/NACK bits. In some implementations, there may be a special value reserved for unreported PDSCH. In some implementations, there may be no special value reserved for unreported PDSCH, with the same value being reserved for other failing cases. In some implementations, each soft ACK/NACK feedback may occupy two bits. Of the two bits, three values may indicate successful reception to be reported in a given codebook, and the fourth value may indicate the opposite: either PDSCH failed, or PDCCH was not received, or the outcome is to be reported in a different uplink slot or sub-slot (e.g., semi-static HARQ codebook generation). In some implementations, dynamic grant and SPS transmissions may be acknowledged by soft ACK/NACK, and each respective hard bit may be replaced by a soft value of B bits.

Under a seventh proposed scheme in accordance with the present disclosure, soft ACK and soft NACK may use 2ⁿ−1 values for OLLA tracking. The last value may be NACK, which may also be generated in case the packet/CBG passes with very low margins. Complementary information may be available separately based on the assumption that NACK occurs infrequently. In a first option, the same codebook may provide the complementary information. In a second option, the complementary information may travel separately, post-mortem. Using the fact that network node 125 knows post-mortem information, network node 125 may trigger resending (as the joint probability of NACK occurrence plus loss of HARQ codebook is minimal). For example, the complementary information may be appended to a subsequent HARQ codebook, implicitly incrementing its size. As another example, the complementary information may be appended to a subsequent aperiodic channel state information (A-CSI) or periodic CSI (P-CSI), implicitly incrementing its size. As yet another example, the complementary information may be provided using any other configured sending opportunity, similar to a scheduling request (SR). In a third option, information may be split between above-described first option and second option. In applying all the options, complementary information may include distinction between failure and “near-misses” (potentially distinguishing in-between multiple levels), similar information on PDCCH scheduling the packet that produced the NACK. Any other information that can be relevant for the cause of failure such as DMRS-based estimates (e.g., channel, noise, SNR, and Doppler), number of codeblocks (CBs), which CB(s) failed, and so on. In applying the second option and the third option, complementary information may carry CSI information measured on DMRS/data tones of the packets that have passed. It may be assumed that each HARQ codebook only generates a single NACK at most. In case that two NACKs are generated then the information content may be reduced. For example, the same, reduced information may be carried for each NACK. Alternatively, information on NACK that occurred first and/or last may be carried.

It is noteworthy that a threshold may be configured closer to decoding failure, indicating an ACK-near-miss event, and used in the detection of sudden channel degradation (e.g., due to interference). Close occurrences in time of ACK-near-miss events may trigger large jumps, similarly to NACK and lowering the confidence of previously acquired statistical parameters. Thus, NACK and ACK-near-miss events may have similar effect on OLLA. In an event that ACK-near-miss events, albeit rare, are allowed to trigger a retransmission, then NACK and ACK-near-miss may be reported by the same value corresponding to NACK. For a post-mortem distinction between the two events, it may be sufficient to add a bit to the next codebook. This concept may be extended to reporting other information post-mortem, such as the reason for failure (e.g., PDCCH-miss versus PDSCH-miss). Until the post-mortem information is available, the schedule may use a combination of the most pessimistic hypotheses.

Under an eighth proposed scheme in accordance with the present disclosure, only type-2 and type-3 codebooks may use soft HARQ.

Under a ninth proposed scheme in accordance with the present disclosure, when spatial bundling is configured, soft ACK/NACK bits may be bundled by reporting the worst value in an event that the decoding on either layer fails. In case that the bundled decoding is successful, then the minimum or the mean may be taken of the values representing reception quality.

With respect to aggregate measurement report, UE 110 may be configured to append CSI information to a codebook that uses the conventional codebook generation based on binary ACK/NACKs or the proposed generation based on soft ACKs. The appended CSI information may be based on an aggregate of measurements over several CBGs, TBs and/or PDSCHs. The set of PDSCH data packets involved in the aggregated measurement may be either: (a) the same set as the data packets acknowledged in the codebook, or (b) a set of the most recently received packets in a sequence. There may be one or two reports appended based on selective aggregation. In a first option, only successful CBGs/packets may impact on the aggregate information. In a second option, only failing CBGs/packets may impact on the aggregate information. In a third option, two reports may be appended, one using the first option and the other using the second option. In some implementations, aggregate values may describe BER probability distributions of the packets (e.g., mean, standard deviation, estimated highest 5%, and so on).

It is noteworthy that, regarding complementary information on NACK (e.g., PDSCH decoding failure or PDCCH miss(es)), conveying complementary information per soft ACK/NACK may not be economical, as NACK occurs infrequently. However, it may be assumed that NACK occurs at most once for any HARQ codebook, thus placeholder bits for the complementary information on NACK may only need to be reserved once per HARQ codebook. To even spare the placeholder bits, the information may piggyback on the next HARQ. Using this technique, near-misses may also be reported as NACK and later discriminated against NACK based on the complementary information. The goal is to save on soft ACK bits and spend the available levels to values that occur frequently.

Under a tenth proposed scheme in accordance with the present disclosure, complementary information on NACK may be available in the UE (e.g. UE 110). This information may include, for example, the following: (a) failure due to PDCCH miss or PDSCH decoding, (b) NACK reported failure or near-miss, (c) DMRS based information about the failure or data based quality information (e.g., block error rate (BLER)) for near-miss, and (d) one or multiple CBs failed if TB failed and information on whether this was due to a local interference peak or a notch in selective fading.

Under an eleventh proposed scheme in accordance with the present disclosure, complementary information on NACK may be conveyed as part of the same HARQ codebook as NACK. Placeholder bits may be appended to all HARQ, sufficient for a single NACK. In the infrequent case where multiple NACKs occur, either the information may be reduced per NACK or only the last NACK has complementary information.

Under a twelfth proposed scheme in accordance with the present disclosure, complementary information on NACK may be conveyed as part of the HARQ codebook that is first scheduled after the NACK was reported and has been decoded by a gNB (e.g., network node 125), as specified by N1 timeline. The complementary information may be appended to multiple NACKs as well. This proposed scheme may be combined with the eleventh proposed scheme, in which case the complementary information may be split between the two codebooks. Until the complementary information is available, the gNB may act on the NACK using the worst hypothesis/combination of hypotheses for defensive scheduling. For instance, in case discrimination between NACK event and near-miss event is awaiting complementary information, then retransmission may be performed. As another example, statistical information may be reset upon both NACK and near-miss. As a variation, post-mortem information may utilize one bit to distinguish between near-miss (e.g., bit=0) and NACK (e.g., bit=1) and may trigger an SR.

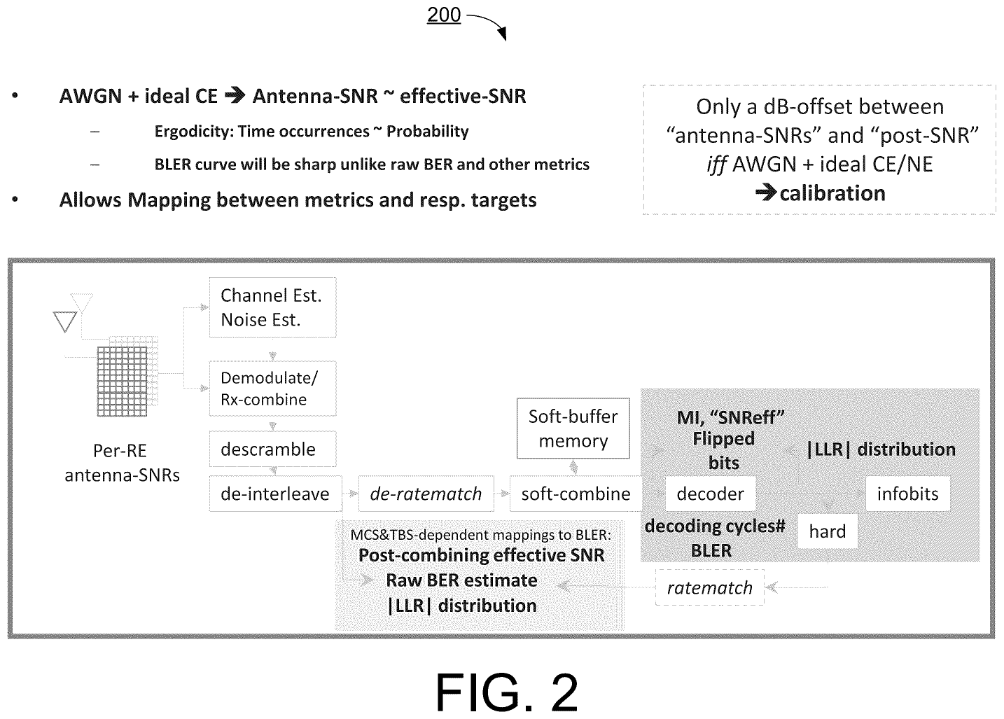

Under a thirteenth proposed scheme in accordance with the present disclosure, on each CB a single metric or any subset of metrics may be measured out of the following set: LDPC iterations, codebook number (CN) updates, VC updates, LDPC processing cycles, flipped bits between the input and the output of the LDPC decoder, history of flipping bits per each cycle of the LDPC decoding, average SNR on the input of the LDPC decoder, mutual information between LLRs, raw BER on the input of the de-rate matcher, SNR on the input of the de-rate matcher, magnitude and variance of LLR values post-reception-combining and/or after de-rate matching. A subset of metrics may change by subranges of the reporting. In some implementations, in counting flipping bits, filler bits may be excluded from the de-rate matcher. Alternatively, in counting flipping bits, filler bits may be included in de-rate matcher with a weight (e.g., 0.5). In some implementations, instead of measuring the flipping bits with respect to soft combiner output, flipping bits may be measured with respect to the soft combiner input. In some implementations, flipping bits may be measured on information bits only. Alternatively, the measurement may be over all flipped bits. FIG. 2 illustrates an example scenario 200 of calibration of metrics with respect to effective SNR under the thirteens proposed scheme.

Under a fourteenth proposed scheme in accordance with the present disclosure, the reference MCS_{ref} used with delta-SNR=fnc2(MCS_{ref}, BLEP_{ref}, BLEP) and delta-log-BLER=fnc1 (MCS_{ref}, BLEP_{ref}, BLEP) may be either of the following: (a) the latest PDSCH successfully received within a same codebook, or (b) the modulation coding scheme (MCS) used per PDSCH for which the delta-SNR is reported. The reference BLER_{ref} may be configured separately from the channel quality indicator (CQI) BLER target, and separately for low-priority and high-priority transmissions, and initial transmissions or retransmissions. The reference BLER_{ref} may be configured separately from the CQI BLER target, and separately for low-priority and high-priority transmissions, and initial transmissions or retransmissions. Similar options may be supported for MCS_{ref}.

### Illustrative Implementations

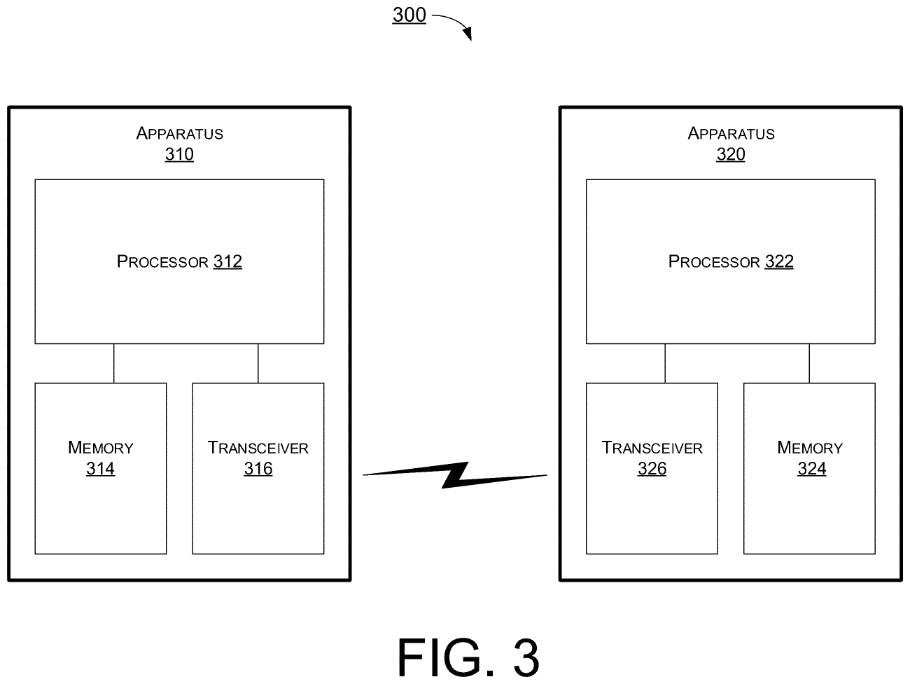

FIG. 3 illustrates an example communication system 300 having at least an example apparatus 310 and an example apparatus 320 in accordance with an implementation of the present disclosure. Each of apparatus 310 and apparatus 320 may perform various functions to implement schemes, techniques, processes and methods described herein pertaining to soft HARQ feedback reporting density, enabling mechanism, processing timeline and code construction in mobile communications, including the various schemes described above with respect to various proposed designs, concepts, schemes, systems and methods described above, including network environment 100, as well as processes described below.

Each of apparatus 310 and apparatus 320 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 310 and apparatus 320 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 310 and apparatus 320 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 310 and apparatus 320 may be implemented in a smart thermostat, a smart fridge, a smart door lock, a wireless speaker or a home control center. When implemented in or as a network apparatus, apparatus 310 and/or apparatus 320 may be implemented in an eNodeB in an LTE, LTE-Advanced or LTE-Advanced Pro network or in a gNB or TRP in a 5G network, an NR network or an IoT network.

In some implementations, each of apparatus 310 and apparatus 320 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 310 and apparatus 320 may be implemented in or as a network apparatus or a UE. Each of apparatus 310 and apparatus 320 may include at least some of those components shown in FIG. 3 such as a processor 312 and a processor 322, respectively, for example. Each of apparatus 310 and apparatus 320 may further include one or more other components not pertinent to the proposed scheme of the present disclosure (e.g., internal power supply, display device and/or user interface device), and, thus, such component(s) of apparatus 310 and apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC or RISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including those pertaining to soft HARQ feedback reporting density, enabling mechanism, processing timeline and code construction in mobile communications in accordance with various implementations of the present disclosure.

In some implementations, apparatus 310 may also include a transceiver 316 coupled to processor 312. Transceiver 316 may be capable of wirelessly transmitting and receiving data. In some implementations, transceiver 316 may be capable of wirelessly communicating with different types of wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs/wireless networks of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, apparatus 310 may further include a memory 314 coupled to processor 312 and capable of being accessed by processor 312 and storing data therein. In some implementations, apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

Each of apparatus 310 and apparatus 320 may be a communication entity capable of communicating with each other using various proposed schemes in accordance with the present disclosure. For illustrative purposes and without limitation, a description of capabilities of apparatus 310, as a UE (e.g., UE 110), and apparatus 320, as a network node (e.g., network node 125) of a wireless network (e.g., network 120 as a 5G/NR mobile network), is provided below.

Under various proposed schemes in accordance with the present disclosure pertaining to soft HARQ feedback reporting density, enabling mechanism, processing timeline and code construction in mobile communications, processor 312 of apparatus 310, implemented in or as UE 110, may receive, via transceiver 316, one or more transmissions (e.g., PDSCH transmissions) from a network node of a wireless network (e.g., apparatus 320 as network node 125 of wireless network 120). Additionally, processor 312 may generate one or more soft HARQ feedbacks corresponding to the one or more transmissions. Moreover, processor 312 may transmit, via transceiver 316, the one or more soft HARQ feedbacks to the network node.

In some implementations, a report in the one or more soft HARQ feedbacks may include measured or estimated soft information in a form of a percentage value of the one or more soft HARQ feedbacks which may be a ratio of a measured or estimated value of the soft information to a maximum value of the soft information. In some implementations, the soft information may include information on one or more of: (a) a number of LDPC decoding iterations; (b) an amount of time needed to complete a PDSCH decoding process; (c) an LLC value; (d) an LLR variance; (e) a number of flipped bits; and (f) a raw BER.

In some implementations, a number of the one or more soft HARQ feedbacks may be less than a number of existing HARQ feedbacks based on a reduction in the number of the one or more soft HARQ feedbacks in a period of N time units. In some implementations, a granularity of the N time units may be a sub-slot, slot or radio frame. In some implementations, measurements of a soft HARQ feedback report per N time unit may be based on one of the following: (a) N PDSCHs from N sub-slots, N slots or N radio frames; (b) one or more PDSCHs per N time unit, wherein the PDSCH is selected due to having a worst decoding performance or a best decoding performance; (c) one or more PDSCHs having been successfully decoded; and (d) one or more PDSCHs having been unsuccessfully decoded.

In some implementations, a processing timeline associated in preparing the one or more soft HARQ feedbacks may be based on one or more of the following: (a) a UE capability; (b) a numerology; (c) an existing UE processing timeline plus an extension; (d) a configuration of a DMRS position; (e) a PDSCH mapping type; (f) a type or method of generating the one or more soft HARQ feedbacks; (g) a type or method of reporting or signaling the one or more soft HARQ feedbacks; (h) a soft HARQ feedback reporting granularity; (i) a soft HARQ feedback reporting density; (j) a number of symbols per PDSCH; (k) a configured BWP size; and (l) a period from an end of a last symbol of a PDSCH carrying a TB or CBG being acknowledged.

In some implementations, the generating and transmitting of the one or more soft HARQ feedbacks may be enabled or disabled based on a priority level of a HARQ-ACK feedback. In some implementations, the priority level may be indicated in DCI or configured in an RRC signal.

In some implementations, the generating and transmitting of the one or more soft HARQ feedbacks may be enabled or disabled based on a PDSCH scheduling mechanism by one or more of the following: (a) enabling for a HARQ-ACK feedback or dynamic scheduling of a PDSCH; (b) enabling for SPS of the PDSCH; (c) enabling or disabling for a PDSCH scheduled by DCI format 1_0, 1_1 or 1_2; and (d) enabling or disabling per SPS configuration.

In some implementations, the one or more soft HARQ feedbacks may include at least one soft ACK or at least one soft NACK or both the soft ACK and the soft NACK. In some implementations, the soft ACK and the soft NACK may be encoded using complementary sets of values based on a same number of representation. In some implementations, a specific value in the soft NACK may indicate an unreported PDSCH.

In some implementations, in generating the one or more soft HARQ feedbacks, processor 312 may generate at least one soft ACK or at least one soft NACK or both the soft ACK and the soft NACK using (2n−1) values for OLLA tracking. In some implementations, n may denote a value of the soft NACK.

In some implementations, in generating the one or more soft HARQ feedbacks, processor 312 may generate the one or more soft HARQ feedbacks using a type-2 or type-3 codebook.

In some implementations, in generating the one or more soft HARQ feedbacks, processor 312 may generate at least one soft ACK or at least one soft NACK or both the soft ACK and the soft NACK. In some implementations, bits of the soft ACK and the soft NACK may be bundled by reporting a worst-case value responsive to both spatial bundling being configured and there being a decoding failure. In some implementations, a minimum or a mean of values representing reception quality may be reported responsive to successful bundled decoding.

In some implementations, in generating the one or more soft HARQ feedbacks, processor 312 may append CSI to a codebook that uses a generation based on soft ACKs. In some implementations, the appended CSI may be based on aggregated measurements over multiple CBGs, TBs or PDSCHs.

In some implementations, a set of PDSCH data packets involved in the aggregated measurements may be same as a set of data packets acknowledged in the codebook. In some implementations, a set of PDSCH data packets involved in the aggregated measurements may include a set of most-recently received packets in a sequence.

In some implementations, the one or more soft HARQ feedbacks may include a NACK with complementary information indicating one or more of the following: (a) a failure due to a PDCCH-miss or a failure in PDSCH decoding; (b) a decoding failure or a near-miss; (c) DMRS-based information about a failure or data-based quality information on a near-miss; and (d) one or more CBs failed.

In some implementations, the one or more soft HARQ feedbacks may include a NACK with complementary information on the NACK and being part of a same HARQ codebook as the NACK with placeholder bits appended to a number of HARQ feedbacks sufficient for a single NACK.

In some implementations, the one or more soft HARQ feedbacks may include a NACK with complementary information on the NACK and being part of a HARQ codebook that is a first scheduled after the NACK is reported to and decoded by the network node.

In some implementations, in generating the one or more soft HARQ feedbacks, processor 312 may measure one or more metrics on each codebook associated with the one or more transmissions. In some implementations, the one or more metrics may include one or more of the following: (a) one or more LDPC iterations; (b) one or more CN updates; (c) one or more LDPC processing cycles; (d) one or more flipped bits between an input and an output of a LDPC decoder; (e) a history of bits flipping per cycle of LDCP decoding; (f) an average SNR on the input of the LDPC decoder; (g) mutual information between LLRs; (h) a raw BER on an input of a de-ratematcher; (i) a SNR on an input of the de-ratematcher; and (j) a magnitude and a variance of LLR values post-receiving-combining or after de-ratematching.

In some implementations, a reference MCS used in generating the one or more soft HARQ feedbacks may be either a latest PDSCH successfully received with a same codebook or a MCS level per PDSCH for which a change in an SNR (e.g., delta-SNR) is reported.

### Illustrative Processes

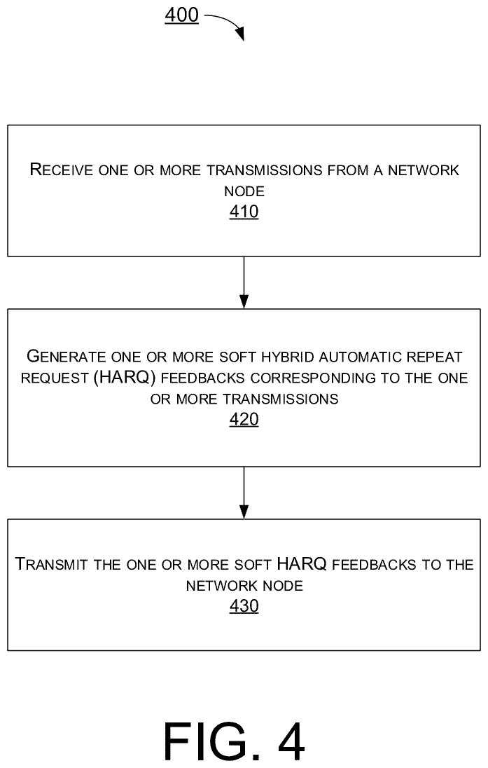

FIG. 4 illustrates an example process 400 in accordance with an implementation of the present disclosure. Process 400 may represent an aspect of implementing various proposed designs, concepts, schemes, systems and methods described above, whether partially or entirely, including those pertaining to those described above. More specifically, process 400 may represent an aspect of the proposed concepts and schemes pertaining to soft HARQ feedback reporting density, enabling mechanism, processing timeline and code construction in mobile communications. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 310 and apparatus 320 as well as any variations thereof. Solely for illustrative purposes and without limiting the scope, process 400 is described below in the context of apparatus 310 as a UE (e.g., UE 110) and apparatus 320 as a communication entity such as a network node or base station (e.g., network node 125) of a wireless network (e.g., wireless network 120). Process 400 may begin at block 410.

At 410, process 400 may involve processor 312 of apparatus 310 receiving, via transceiver 316, one or more transmissions (e.g., PDSCH transmissions) from a network node of a wireless network (e.g., apparatus 320 as network node 125 of wireless network 120). Process 400 may proceed from 410 to 420.

At 420, process 400 may involve processor 312 generating one or more soft HARQ feedbacks corresponding to the one or more transmissions. Process 400 may proceed from 420 to 430.

At 430, process 400 may involve processor 312 transmitting, via transceiver 316, the one or more soft HARQ feedbacks to the network node.

In some implementations, a report in the one or more soft HARQ feedbacks may include measured or estimated soft information in a form of a percentage value of the one or more soft HARQ feedbacks which may be a ratio of a measured or estimated value of the soft information to a maximum value of the soft information. In some implementations, the soft information may include information on one or more of: (a) a number of LDPC decoding iterations; (b) an amount of time needed to complete a PDSCH decoding process; (c) an LLC value; (d) an LLR variance; (e) a number of flipped bits; and (f) a raw BER.

In some implementations, a number of the one or more soft HARQ feedbacks may be less than a number of existing HARQ feedbacks based on a reduction in the number of the one or more soft HARQ feedbacks in a period of N time units. In some implementations, a granularity of the N time units may be a sub-slot, slot or radio frame. In some implementations, measurements of a soft HARQ feedback report per N time unit may be based on one of the following: (a) N PDSCHs from N sub-slots, N slots or N radio frames; (b) one or more PDSCHs per N time unit, wherein the PDSCH is selected due to having a worst decoding performance or a best decoding performance; (c) one or more PDSCHs having been successfully decoded; and (d) one or more PDSCHs having been unsuccessfully decoded.

In some implementations, a processing timeline associated in preparing the one or more soft HARQ feedbacks may be based on one or more of the following: (a) a UE capability; (b) a numerology; (c) an existing UE processing timeline plus an extension; (d) a configuration of a DMRS position; (e) a PDSCH mapping type; (f) a type or method of generating the one or more soft HARQ feedbacks; (g) a type or method of reporting or signaling the one or more soft HARQ feedbacks; (h) a soft HARQ feedback reporting granularity; (i) a soft HARQ feedback reporting density; (j) a number of symbols per PDSCH; (k) a configured BWP size; and (l) a period from an end of a last symbol of a PDSCH carrying a TB or CBG being acknowledged.

In some implementations, the generating and transmitting of the one or more soft HARQ feedbacks may be enabled or disabled based on a priority level of a HARQ-ACK feedback. In some implementations, the priority level may be indicated in DCI or configured in an RRC signal.

In some implementations, the generating and transmitting of the one or more soft HARQ feedbacks may be enabled or disabled based on a PDSCH scheduling mechanism by one or more of the following: (a) enabling for a HARQ-ACK feedback or dynamic scheduling of a PDSCH; (b) enabling for SPS of the PDSCH; (c) enabling or disabling for a PDSCH scheduled by DCI format 1_0, 1_1 or 1_2; and (d) enabling or disabling per SPS configuration.

In some implementations, the one or more soft HARQ feedbacks may include at least one soft ACK or at least one soft NACK or both the soft ACK and the soft NACK. In some implementations, the soft ACK and the soft NACK may be encoded using complementary sets of values based on a same number of representation. In some implementations, a specific value in the soft NACK may indicate an unreported PDSCH.

In some implementations, in generating the one or more soft HARQ feedbacks, process 400 may involve processor 312 generating at least one soft ACK or at least one soft NACK or both the soft ACK and the soft NACK using (2n−1) values for OLLA tracking. In some implementations, n may denote a value of the soft NACK.

In some implementations, in generating the one or more soft HARQ feedbacks, process 400 may involve processor 312 generating the one or more soft HARQ feedbacks using a type-2 or type-3 codebook.

In some implementations, in generating the one or more soft HARQ feedbacks, process 400 may involve processor 312 generating at least one soft ACK or at least one soft NACK or both the soft ACK and the soft NACK. In some implementations, bits of the soft ACK and the soft NACK may be bundled by reporting a worst-case value responsive to both spatial bundling being configured and there being a decoding failure. In some implementations, a minimum or a mean of values representing reception quality may be reported responsive to successful bundled decoding.

In some implementations, in generating the one or more soft HARQ feedbacks, process 400 may involve processor 312 appending CSI to a codebook that uses a generation based on soft ACKs. In some implementations, the appended CSI may be based on aggregated measurements over multiple CBGs, TBs or PDSCHs.

In some implementations, a set of PDSCH data packets involved in the aggregated measurements may be same as a set of data packets acknowledged in the codebook. In some implementations, a set of PDSCH data packets involved in the aggregated measurements may include a set of most-recently received packets in a sequence.

In some implementations, the one or more soft HARQ feedbacks may include a NACK with complementary information indicating one or more of the following: (a) a failure due to a PDCCH-miss or a failure in PDSCH decoding; (b) a decoding failure or a near-miss; (c) DMRS-based information about a failure or data-based quality information on a near-miss; and (d) one or more CBs failed.

In some implementations, the one or more soft HARQ feedbacks may include a NACK with complementary information on the NACK and being part of a same HARQ codebook as the NACK with placeholder bits appended to a number of HARQ feedbacks sufficient for a single NACK.

In some implementations, the one or more soft HARQ feedbacks may include a NACK with complementary information on the NACK and being part of a HARQ codebook that is a first scheduled after the NACK is reported to and decoded by the network node.

In some implementations, in generating the one or more soft HARQ feedbacks, process 400 may involve processor 312 measuring one or more metrics on each codebook associated with the one or more transmissions. In some implementations, the one or more metrics may include one or more of the following: (a) one or more LDPC iterations; (b) one or more CN updates; (c) one or more LDPC processing cycles; (d) one or more flipped bits between an input and an output of a LDPC decoder; (e) a history of bits flipping per cycle of LDCP decoding; (f) an average SNR on the input of the LDPC decoder; (g) mutual information between LLRs; (h) a raw BER on an input of a de-ratematcher; (i) a SNR on an input of the de-ratematcher; and (j) a magnitude and a variance of LLR values post-receiving-combining or after de-ratematching.

In some implementations, a reference MCS used in generating the one or more soft HARQ feedbacks may be either a latest PDSCH successfully received with a same codebook or a MCS level per PDSCH for which a change in an SNR (e.g., delta-SNR) is reported.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving one or more transmissions from a network node;
generating one or more soft hybrid automatic repeat request (HARQ) feedbacks corresponding to the one or more transmissions; and
transmitting the one or more soft HARQ feedbacks to the network node.

2. The method of claim 1, wherein a report in the one or more soft HARQ feedbacks comprises measured or estimated soft information in a form of a percentage value of the one or more soft HARQ feedbacks which is a ratio of a measured or estimated value of the soft information to a maximum value of the soft information.

3. The method of claim 2, wherein the soft information comprises information on one or more of:
a number of low-density parity-check (LDPC) decoding iterations;
an amount of time needed to complete a physical downlink shared channel (PDSCH) decoding process;
a log-likelihood ratio (LLR) value;
an LLR variance;
a number of flipped bits; and
a raw bit error rate (BER).

4. The method of claim 1, wherein a number of the one or more soft HARQ feedbacks is less than a number of existing HARQ feedbacks based on a reduction in the number of the one or more soft HARQ feedbacks in a period of N time units, and wherein a granularity of the N time units is a sub-slot, slot or radio frame.

5. The method of claim 4, wherein measurements of a soft HARQ feedback report per N time unit is based on one of:
N physical downlink shared channels (PDSCHs) from N sub-slots, N slots or N radio frames;
one or more PDSCHs per N time unit, wherein the PDSCH is selected due to having a worst decoding performance or a best decoding performance;
one or more PDSCHs having been successfully decoded; and
one or more PDSCHs having been unsuccessfully decoded.

6. The method of claim 1, wherein a processing timeline associated in preparing the one or more soft HARQ feedbacks is based on one or more of:
a user equipment (UE) capability;
a numerology;
an existing UE processing timeline plus an extension;
a configuration of a demodulation reference signal (DMRS) position;
a physical downlink shared channel (PDSCH) mapping type;
a type or method of generating the one or more soft HARQ feedbacks;
a type or method of reporting or signaling the one or more soft HARQ feedbacks;
a soft HARQ feedback reporting granularity;
a soft HARQ feedback reporting density;
a number of symbols per PDSCH;
a configured bandwidth part (BWP) size; and
a period from an end of a last symbol of a PDSCH carrying a transport block (TB) or codeblock group (CBG) being acknowledged.

7. The method of claim 1, wherein the generating and transmitting of the one or more soft HARQ feedbacks is enabled or disabled based on a priority level of a HARQ acknowledgement (HARQ-ACK) feedback, and wherein the priority level is indicated in downlink control information (DCI) or configured in a radio resource control (RRC) signal.

8. The method of claim 1, wherein the generating and transmitting of the one or more soft HARQ feedbacks is enabled or disabled based on a physical downlink shared channel (PDSCH) scheduling mechanism by one or more of:
enabling for a HARQ acknowledgement (HARQ-ACK) feedback or dynamic scheduling of a PDSCH;
enabling for semi-persistent scheduling (SPS) of the PDSCH;
enabling or disabling for a PDSCH scheduled by downlink control information (DCI) format 1_0, 1_1 or 1_2; and
enabling or disabling per SPS configuration.

9. The method of claim 1, wherein the one or more soft HARQ feedbacks comprise at least one soft acknowledgement (ACK) or at least one soft negative acknowledgement (NACK) or both the soft ACK and the soft NACK, wherein the soft ACK and the soft NACK are encoded using complementary sets of values based on a same number of representation, and wherein a specific value in the soft NACK indicates an unreported physical downlink shared channel (PDSCH).

10. The method of claim 1, wherein the generating of the one or more soft HARQ feedbacks comprises generating at least one soft acknowledgement (ACK) or at least one soft negative acknowledgement (NACK) or both the soft ACK and the soft NACK using (2ⁿ−1) values for outer loop link adaptation (OLLA) tracking, and wherein n denotes a value of the soft NACK.

11. The method of claim 1, wherein the generating of the one or more soft HARQ feedbacks comprises generating the one or more soft HARQ feedbacks using a type-2 or type-3 codebook.

12. The method of claim 1, wherein the generating of the one or more soft HARQ feedbacks comprises generating at least one soft acknowledgement (ACK) or at least one soft negative acknowledgement (NACK) or both the soft ACK and the soft NACK, wherein bits of the soft ACK and the soft NACK are bundled by reporting a worst-case value responsive to both spatial bundling being configured and there being a decoding failure, and wherein a minimum or a mean of values representing reception quality is reported responsive to successful bundled decoding.

13. The method of claim 1, wherein the generating of the one or more soft HARQ feedbacks comprises appending channel state information (CSI) to a codebook that uses a generation based on soft acknowledgements (ACKs), and wherein the appended CSI is based on aggregated measurements over multiple codeblock groups (CBGs), transport blocks (TBs) or physical downlink shared channels (PDSCHs).

14. The method of claim 13, wherein a set of PDSCH data packets involved in the aggregated measurements is same as a set of data packets acknowledged in the codebook.

15. The method of claim 13, wherein a set of PDSCH data packets involved in the aggregated measurements comprises a set of most-recently received packets in a sequence.

16. The method of claim 1, wherein the one or more soft HARQ feedbacks comprise a negative acknowledgement (NACK) with complementary information indicating one or more of:
a failure due to a physical downlink control channel (PDCCH) miss or a failure in physical downlink shared channel (PDSCH) decoding;
a decoding failure or a near-miss;
demodulation reference signal (DMRS)-based information about a failure or data-based quality information on a near-miss; and
one or more codebooks (CBs) failed.

17. The method of claim 1, wherein the one or more soft HARQ feedbacks comprise a negative acknowledgement (NACK) with complementary information on the NACK and being part of a same HARQ codebook as the NACK with placeholder bits appended to a number of HARQ feedbacks sufficient for a single NACK.

18. The method of claim 1, wherein the one or more soft HARQ feedbacks comprise a negative acknowledgement (NACK) with complementary information on the NACK and being part of a HARQ codebook that is a first scheduled after the NACK is reported to and decoded by the network node.

19. The method of claim 1, wherein the generating of the one or more soft HARQ feedbacks comprises measuring one or more metrics on each codebook associated with the one or more transmissions, and wherein the one or more metrics comprise one or more of:
one or more low-density parity-check (LDPC) iterations;
one or more codebook number (CN) updates;
one or more LDPC processing cycles;
one or more flipped bits between an input and an output of a LDPC decoder;
a history of bits flipping per cycle of LDCP decoding;
an average signal-to-noise ratio (SNR) on the input of the LDPC decoder;
mutual information between log-likelihood ratios (LLRs);
a raw bit error rate (BER) on an input of a de-ratematcher;
a SNR on an input of the de-ratematcher; and
a magnitude and a variance of LLR values post-receiving-combining or after de-ratematching.

20. The method of claim 1, wherein a reference modulation coding scheme (MCS) used in generating the one or more soft HARQ feedbacks is either a latest physical downlink shared channel (PDSCH) successfully received with a same codebook or a MCS level per PDSCH for which a change in a signal-to-noise ratio (SNR) is reported.
